(19) United States
(12) Patent Application Publication
(10) Pub. No.: US 2019/0168835 A1
(43) Pub. Date: Jun. 6, 2019

(54) PERSONAL MOBILITY KIT

(71) Applicant: Ford Global Technologies, LLC, Dearborn, MI (US)

(72) Inventor: Dante Jaime HERNANDEZ, Tlalnepantla (MX)

(21) Appl. No.: 16/324,987

(22) PCT Filed: Aug. 15, 2016
(86) PCT No.: PCT/US2016/046995

§ 371 Date: Feb. 12, 2019

(51) Int. Cl. B62K 13/00; B62K 21/16; B62J 1/12; B62J 1/14; B62J 1/16; B62K 3/00; B62K 5/01

(52) U.S. Cl. CPC B62K 13/00; B62K 21/16; B62J 1/12; B62J 1/14; B62K 15/006; B62K 3/002; B62K 5/01; B62K 2204/00; B62J 1/16

(57) ABSTRACT

A kit includes a deck, which has two mounting holes spaced along a longitudinal axis of the deck. A plurality of wheels are supported by the deck. An occupant support includes a post alternately and removably engageable with the mounting holes. A handlebar extends away from the deck along a handlebar axis and is rotatable about the handlebar axis between a forward operating position and a rearward operating position. The interchangeability of the occupant support in the mounting holes and the adjustment of the handlebar between the forward and rearward operating positions allows for the kit to be reconfigured to a variety of configurations.

### BACKGROUND

Personal mobility vehicles, such as scooters, wheelchairs, and bikes, are often used to commute from one location to another. However, these vehicles can only be used conveniently in limited environments. Accordingly, personal mobility vehicles may be used in conjunction with other vehicles, e.g., automobiles, busses, trains, etc. In other words, the personal mobility device may be used as one mode of a multimodal transportation system. For example, in this system, an operator may drive the personal mobility vehicle to the other vehicle, and the other vehicle may transport both the operator and the personal mobility vehicle to a destination. When the destination is reached, the personal mobility vehicle may be driven to a final destination.

### BRIEF DESCRIPTION OF THE DRAWINGS

FIG. 1 is a partially exploded view of a kit including a deck and a plurality of occupant supports alternately connectable to the deck.

FIG. 2 is a perspective view of the kit in a forward operating position.

FIG. 3 is a perspective view of the kit in the forward operating position where the occupant support is a bicycle saddle.

FIG. 4 is a perspective view of the kit in the forward operating position where the occupant support is a bench seat.

FIG. 5 is a perspective view of the kit in the forward operating position where the occupant support is a captain chair.

FIG. 6 is a perspective view of the kit in a rearward operating position where the occupant support is a captain chair.

FIG. 7 is a perspective view of a multimodal transportation system including the kit and an automobile, with the captain chair alternately connectable to the deck and to the automobile.

FIG. 8A is a perspective view of the kit being inserted into the automobile for transportation and charging.

FIG. 8B is a magnified view of the kit of FIG. 8A.

### DETAILED DESCRIPTION

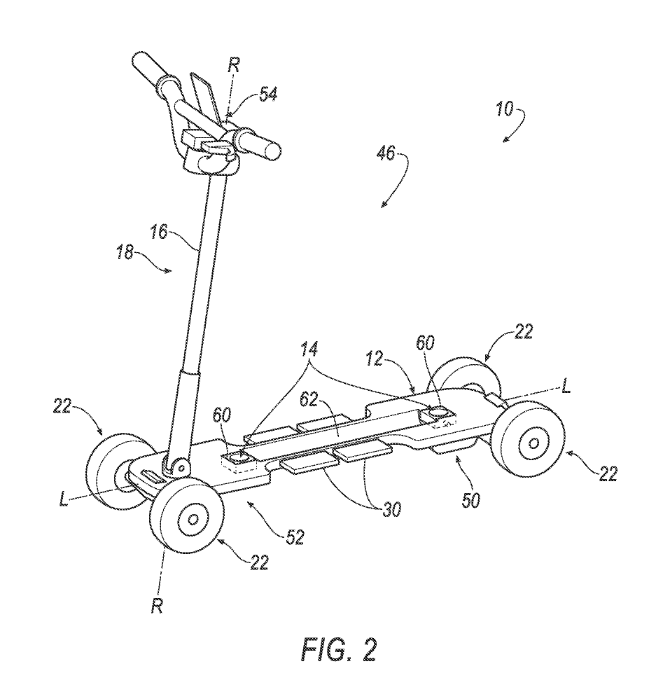

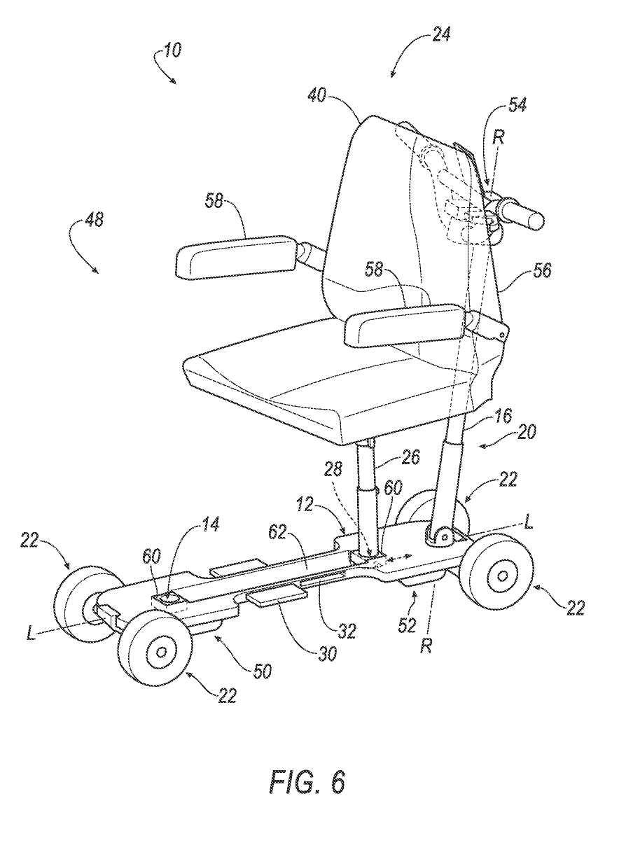

With reference to the Figures, wherein like numerals indicate like parts throughout the several views, a kit 10 includes a deck 12, which has two mounting holes 14 spaced along a longitudinal axis L of the deck 12, and a plurality of wheels 22 supported by the deck 12. The kit 10 includes an occupant support 24 that has a post 26 alternately and removably engageable with the mounting holes 14. A handlebar 16 extends away from the deck 12 along a handlebar axis R and is rotatable about the handlebar axis R between a forward operating position (as shown in FIGS. 2-5) and a rearward operating position (as shown in FIG. 6).

Since the occupant support 24 is alternately and removeably engageable with the two mounting holes 14, the kit 10 can be reconfigurable by moving the occupant support 24 between the mounting holes 14. In addition, the handlebar 16 may be selectively rotated about the handlebar axis R between the forward and rearward operating positions based on the position of the occupant support 24 in the mounting holes 14 and the intended use of the kit 10, as described further below.

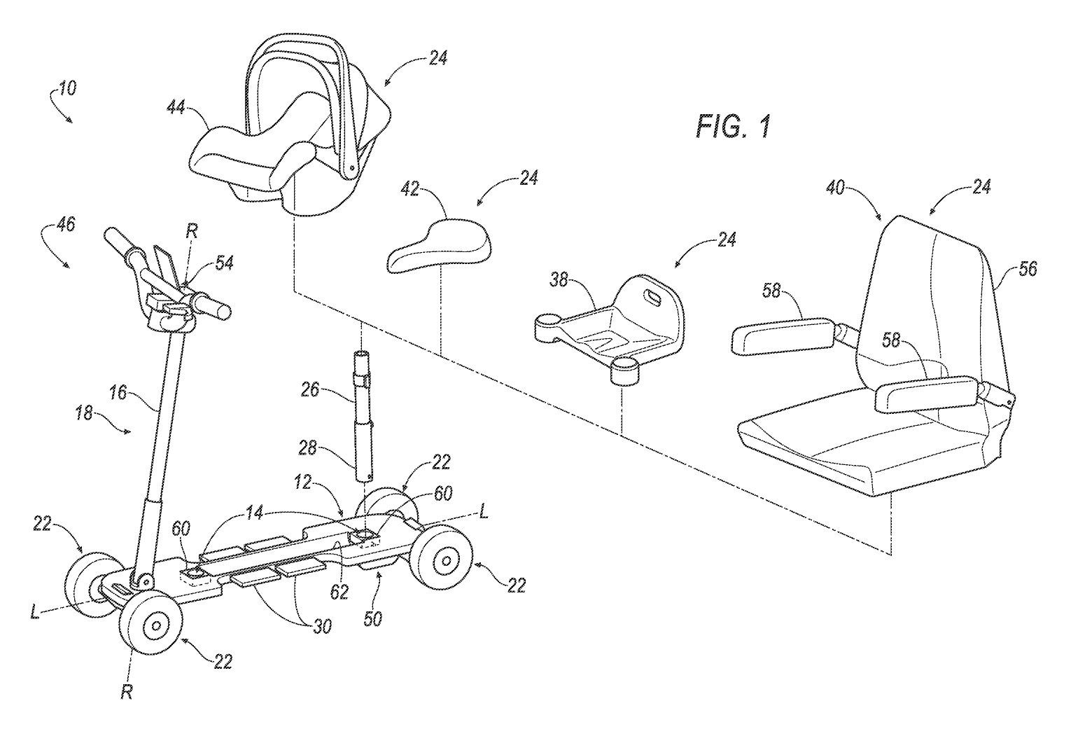

With reference to FIG. 1, the kit 10 may include a plurality of occupant supports 24, each interchangeably engageable with the deck 12. Each of the occupant supports 24 may include the post 26, as shown in FIG. 1. The kit 10 may be reconfigurable into a plurality of configurations by changing which occupant support 24 is engaged with the deck 12, which mounting hole 14 the occupant support 24 is engaged with, and which position the handlebar is positioned in. Some examples of the various configurations are shown in FIGS. 2-6. However, the kit 10 may be reconfigured into any suitable configuration.

The post 26 supports the occupant support 24 and other components of the kit 10 on the deck 12. The post 26 is detachable from the deck 12 and can be engaged in two different positions on the deck 12, i.e., in either of the mounting holes 14.

The post 26 may be removeably engaged with the deck 12 in any suitable way. For example, the post 26 may be inserted into the selected mounting hole 14. The deck 12 may include additional features in the mounting holes 14 for engaging the post 26, e.g., another post (not shown) in the mounting hole 14 that telescopically engages the post 26 when the post 26 is inserted into the selected mounting hole 14.

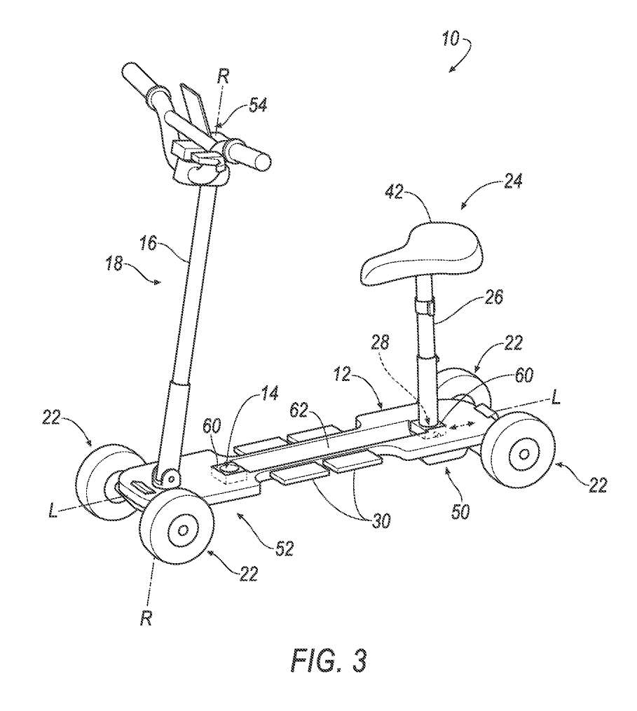

The kit 10 may include a lock 28 on the deck 12 releasably engageable with the post 26, as shown in FIGS. 3 and 6. The lock 28 may be of any suitable type. For example, as shown in FIGS. 3-6, the lock 28 may include a pin (not numbered) in each mounting hole 14 that retractably engages the post 26 when the post 26 is in the respective mounting hole 14. The lock 28 may be actuated between a locked position engaged with the post 26 or an unlocked position disengaged with the post 26 in any suitable manner, e.g., any suitable electronic way or any suitable manual way. The lock 28 may engage the post 26 in any suitable way, e.g., frictional engagement, interlocking engagement, etc.

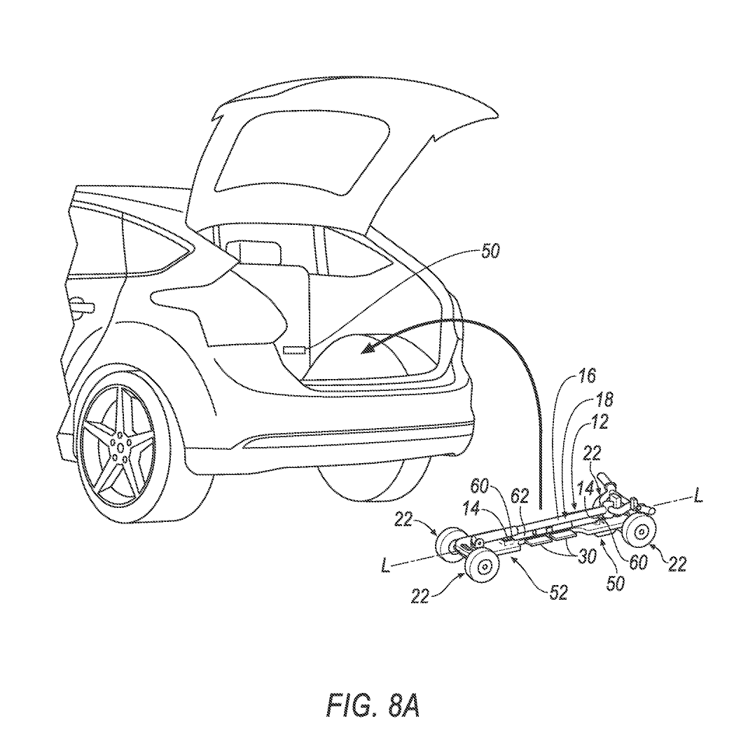

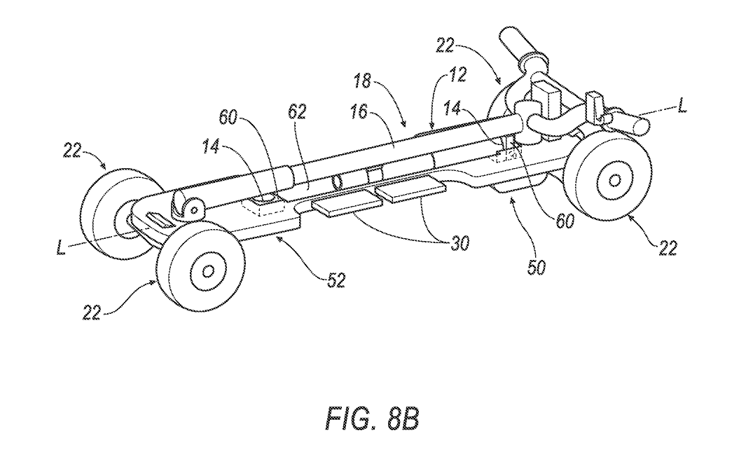

The deck 12 may include pivot block 60 defining the mounting holes 14. The pivot blocks 60 are pivotally supported by the rest of the deck 12 and releasably engagable with the post 26, i.e., in the mounting holes 14. The pivot block 60 may pivot relative to the rest of the deck 12 between an upright position, as shown in FIGS. 1-7 and a stowed position, as shown in FIGS. 8A-B. The pivot block 60 may be releasably locked in the upright position and the stowed position in any suitable manner, e.g., pins, locks, etc.

The deck 12 may define a groove 62 extending from one of the pivot blocks 60 to the other of the pivot blocks 60. The groove 62 may be semi-cylindrical in shape, or, alternatively, may be any suitable shape. The groove 62 may receive the post 26 in the stowed position, as shown in FIGS. 8A-B.

As set forth above, the handlebar 16 of the kit 10 is removably attached to the deck 12. For example, the deck 12 may include a hole (not numbered) that removeably receives the handlebar 16. The handlebar 16 may be foldable relative to the deck 12, as shown in FIGS. 8A-B. The deck 12 and/or the handlebar 16 may, for example, include a pivoting feature (not numbered) that allows the handlebar 16 to pivot toward the deck 12 for storage and/or ease of transportation. The handlebar 16 is positioned at an end (not numbered) of the deck 12.

As set forth above, the handlebar 16 is rotatable around the handlebar axis R between the forward operating position and the reverse operating position. The forward operating position constitutes the kit 10 being operated from someone on the deck 12 and the reverse operating position constitutes the kit 10 being operated from off of the deck 12.

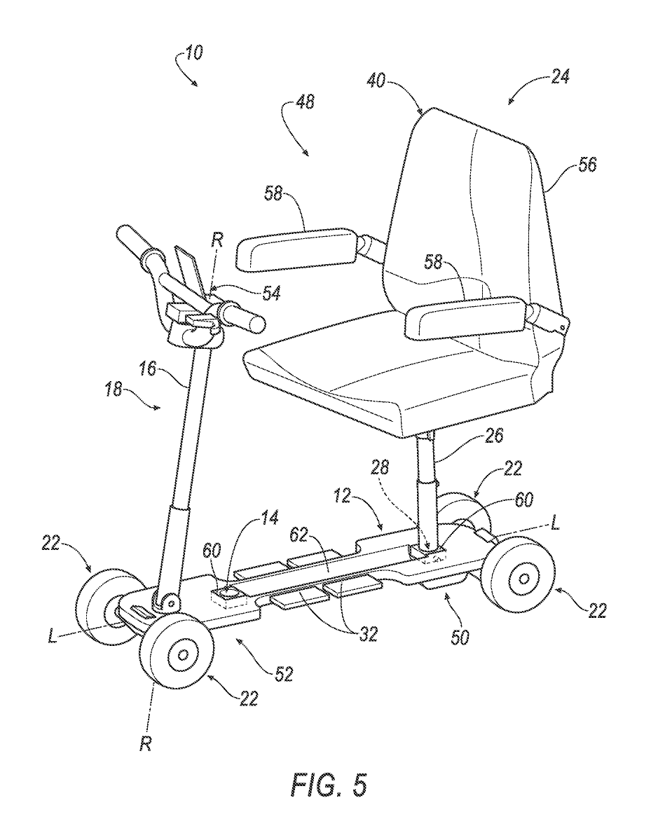

The length of the handlebar 16 is adjustable along the handlebar axis R. For example, the handlebar 16 may include telescoping tubes that telescopically extend and retract relative to each other. The handlebar 16 may be elongated to an extended position (as shown in FIGS. 1-4 and 6) and may be retracted to a retracted position (as shown in FIG. 5).

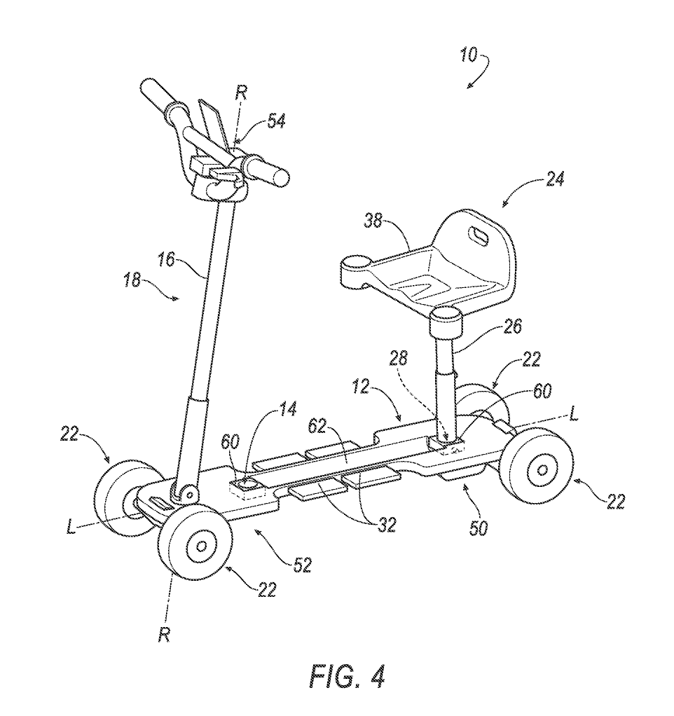

The kit 10 includes two pegs 30 supported by the deck 12. Specifically, the deck 12 defines a plurality of slots 32 spaced along the longitudinal axis L. The slots 32 are configured to removeably support the pegs 30. The slots 32 allow for the pegs 30 to be placed in different positions along the deck 12 depending on the desired configuration of the kit 10. For example, the pegs 30 may be removed completely (as shown in FIGS. 4 and 5), moved to a forward position (as shown in FIG. 6), moved to a rearward position (not shown), or moved to a double position (as shown in FIGS. 2 and 3). The deck 12, specifically, includes two sets of slots 32 spaced from each other along the longitudinal axis L, and the two pegs 30 are alternately and removeably engageable with the two sets of slots 32. In other words, one peg 30 may be inserted into one slot 32, and may be selectively moved to unoccupied slots 32. In the alternative to discrete slots 32, the deck 12 may include a single elongated slot (not shown), and a single peg may be slideably engaged in the elongated slot and moveable along the slot to any suitable position.

The kit 10 may be manually powered and/or may include a motor 50 supported by the deck 12. As one example, the motor 50 may be a hub motor on one or more of the wheels 22. In other words, the motor 50 may be supported on the wheel to rotate an outer member, e.g., a tire, relative to an inner member, e.g., a hub. As another example, the motor 50 may be directly connected to the deck 12 or may be connected to the deck 12 through an intermediate component (not shown), such as in the case of the hub motors. The motor 50 may be electrically powered. Alternatively the motor 50 may be of any suitable type.

The kit 10 may include a battery 52 supported by the deck 12 and in electrical communication with the motor 50. The battery 52 may be directly connected to the deck 12 or may be connected to the deck 12 through an intermediate component. The battery 52 may also power other devices on the kit 10 in addition to the motor, e.g., a charging port 54 for a mobile phone. The battery 52 may be rechargeable and may be of any suitable type.

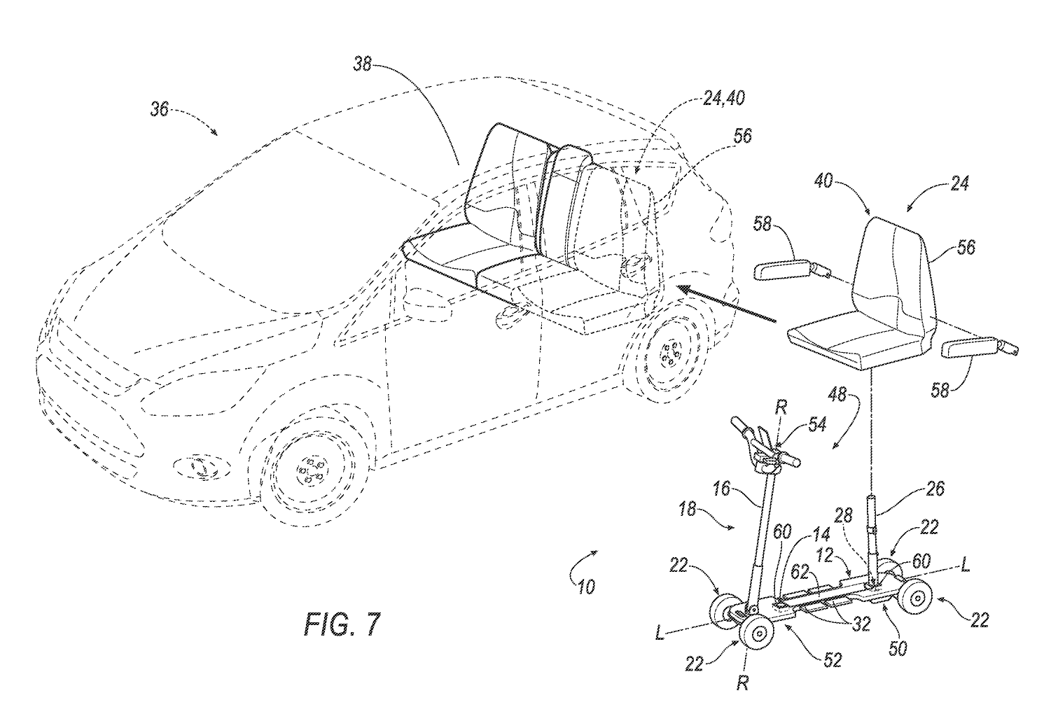

As set forth above, the kit 10 may include a plurality of occupant supports 24. For example, one of the occupant supports 24 may be a bicycle saddle 42, as shown in FIG. 3. As another example, one of the occupant supports 24 may be a bench seat 38, as shown in FIG. 4. As another example, one of the occupant supports 24 may be a captain chair 40, as shown in FIGS. 5 and 6. As shown in FIG. 7, and as described further below, the captain chair 40 may be installed into an automobile 36 for seating an occupant of the automobile 36. As another example, one of the occupant supports 24 may be a bassinet 44, as shown in FIG. 1. Alternatively, or in addition to the types of occupant supports 24 described above, the occupant supports 24 may be of any suitable type.

The kit 10 may be rearranged into a variety of configurations, e.g., a first configuration, a second configuration, etc. The adjectives “first,” “second,” etc . . . , are used herein as identifiers and are not intended to indicate order or importance. As one example, with reference to FIGS. 5 and 6, in one configuration, one of the occupant supports 24 is engaged with one of the mounting holes 14 and the handlebar 16 is in the forward operating position (as shown in FIG. 5); and in another configuration, the occupant support 24 is engaged with the other of the mounting holes 14 and the handlebar 16 is in the rearward position (as shown in FIG. 6). As another example, with reference to FIGS. 2-4 and 6, in one configuration, one of the occupant supports 24 is engaged with one of the mounting holes 14 and the handlebar 16 is in the forward operating position (as shown in each of FIGS. 2-4); and in another configuration, a different one of the occupant supports 24 is engaged with the other of the mounting holes 14 and the handlebar 16 is in the rearward operating position (as shown in FIG. 6). In these different configurations, the handlebar 16 may be moved between the extended position and the retracted position, as desired, and the pegs 30 may be engaged with any of the slots 32, as desired.

As shown in FIG. 2, the kit 10 may take the form of a scooter 46. In this configuration none of the occupant supports are engaged with the deck 12. The user of the scooter 46 may stand on the deck 12. In this configuration, the handlebar 16 may be positioned in the forward operating position and may be adjusted to the desired height for operation. As shown in FIG. 3, the bicycle saddle 42 may be engaged with the deck 12. In this configuration, the handlebar 16 may be positioned in the forward operating position and may be adjusted to the desired height for operation. The bicycle saddle 24 may also be engageable with a frame of a bicycle (not shown). Accordingly, the bicycle saddle 24 may be interchangeably used with the deck 12 and the bicycle, e.g., in a multimodal transportation system.

As shown in FIG. 4, the bench seat 38 may be engaged with the deck 12. In this configuration, the handlebar 16 may be positioned in the forward facing position and may be adjusted to the desired height for operation. In this configuration, the pegs 30 may be omitted, as shown in FIG. 4.

As shown in FIG. 5, the captain chair 40. In this configuration, the post 26 may be engaged with the mounting hole 14 furthest from the handlebar 16. In this configuration, the handlebar 16 may be positioned in the forward operating position and may be adjusted to the desired height for operation, e.g., the extended position. In this configuration, the pegs 30 may be omitted, as shown in FIG. 5. In the configuration shown in FIG. 5, the kit 10 may be operated by the occupant as a wheelchair 48. As another, in the configuration shown in FIG. 6, the kit may be operated as a wheelchair 48 by a person other than the occupant.

Specifically, in the configuration shown in FIG. 6, the post 26 of the captain chair 40 may be supported in the mounting hole 14 nearest the handlebar 16. In this configuration, the handlebar 16 may be positioned in the rearward operating position and may be adjusted to the desired height for operation, e.g., the retracted position. In this configuration, pegs 30 may be positioned in the forward position.

The captain chair 40 may have a seat back 56 and armrests 58. The armrests 58 may be removable from the seatback, as shown in FIG. 7.

With continued reference to FIG. 7, and as introduced above, the captain chair 40 may be interchangeable between the kit 10 and the automobile 36. Specifically, the automobile 36 may include an interior 38 configured to receive the captain chair 40 when disengaged with the deck 12. In other words, the captain chair 40 may be detached from the deck 12 and attached to the interior 38 of the vehicle 36. In this configuration, the armrests 58 may be attached to the seatback for use with the deck 12, and may be removed from the seatback for use in the automobile.

With reference to FIG. 8, components of the kit 10 may be stored in the automobile 36. Specifically, the deck 12 may be stored in a trunk of the automobile 36, as shown in FIG. 8. In this configuration, the automobile 36 may include a charging dock 54 in the trunk. The deck 12 and the charging dock may be configured such that the battery 52 of the kit 10 may be electrically connected to the charging dock to charge the battery 52 with a battery of the automobile 36. Other components of the kit 10 may also be stored in the trunk, e.g., the post 26, the handlebar 16, the armrests 58, etc.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A kit comprising:
a deck having two mounting holes spaced along a longitudinal axis of the deck;
a plurality of wheels supported by the deck;
an occupant support including a post alternately and removably engageable with the mounting holes; and
a handlebar extending away from the deck along a handlebar axis and being rotatable about the handlebar axis between a forward operating position and a rearward operating position.

2. A kit as set forth in claim 1, wherein, in a first configuration, the occupant support is engaged with one of the mounting holes and the handlebar is in the forward operating position and, in a second configuration, the occupant support is engaged with the other of the mounting holes and the handlebar is in the rearward operating position.

3. A kit as set forth in claim 1 further comprising a second occupant support including a post removably engageable with at least one of the mounting holes.

4. A kit as set forth in claim 3 wherein, in a first configuration, the occupant support is engaged with one of the mounting holes and the handlebar is in the forward operating position and, in a second configuration, the second occupant support is engaged with the other of the mounting holes and the handlebar is in the rearward operating position.

5. A kit as set forth in claim 4 wherein a length of the handlebar is adjustable along the handlebar axis, and wherein the handlebar is elongated to an extended position in the first configuration and is retracted to a retracted position in the second configuration.

6. A kit as set forth in claim 5 wherein the deck includes two sets of slots spaced from each other along the longitudinal axis, and further comprising two pegs alternately and removeably engageable with the two sets of slots, wherein the pegs are engaged with one of the sets of slots in the first configuration and are engaged with the other of the set of slots in the second configuration.

7. A kit as set forth in claim 3 wherein the occupant support is one of a bench seat, a captain chair, a bike saddle, and a bassinet, and wherein the second occupant support is another of a bench seat, a captain chair, a bike saddle, and a bassinet.

8. A kit as set forth in claim 1 further comprising a lock on the deck releasably engageable with the post.

9. A kit as set forth in claim 1 wherein a length of the handlebar is adjustable along the handlebar axis.

10. A kit as set forth in claim 1 further comprising two pegs supported by the deck.

11. A kit as set forth in claim 10 further comprising a plurality of slots spaced along the longitudinal axis, the slots being configured to removably support the pegs.

12. A kit as set forth in claim 1 further comprising a motor supported by the deck.

13. A kit as set forth in claim 12 further comprising a battery supported by the deck and in communication with the motor.

14. A kit as set forth in claim 1 wherein the occupant support is an automobile seat.

15. A kit as set forth in claim 14 further comprising an automobile including an interior configured to receive the automobile seat when disengaged with the deck.
